(19) United States
(12) Patent Application Publication
(10) Pub. No.: US 2008/0203271 A1
(43) Pub. Date: Aug. 28, 2008

(54) METHOD OF MANUFACTURING A REPLICA MOLD AND A REPLICA MOLD

(75) Inventors: Motoki Okinaka, Saitama (JP); Kazuhito Tsukagoshi, Saitama (JP); Yoshinobu Aoyagi, Saitama (JP); Hiroshi Tsushima, Osaka (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: RIKEN, Wako-shi (JP); NIPPON PAINT CO., LTD, Osaka (JP)

(21) Appl. No.: 11/845,621

(22) Filed: Aug. 27, 2007

(30) Foreign Application Priority Data
Feb. 27, 2007 (JP) 2007-046969

(51) Int. Cl. B29C 39/10; B29C 33/08; B29C 35/08

(52) U.S. Cl. 249/114.1; 264/430

(57) ABSTRACT

There are provided a replica mold which is excellent in transferring a pattern of a master mold, and also has notably excellent hardness, transparency, heat resistance and chemical resistance, and a simple and inexpensive method of manufacturing the replica mold. A method of manufacturing a replica mold according to the present invention includes the steps of: applying, to a substrate, a replica mold material containing a polysilane and a silicone compound; pressing a master mold on which a predetermined minute pattern has been formed to the replica mold material which has been applied to the substrate; irradiating energy rays from a side of the substrate while the master mold is contacted by press with the replica mold material; releasing the master mold; and irradiating the replica mold material with energy rays from a side to which the master mold has been pressed.

This application claims priority under 35 U.S.C. Section 119 to Japanese Patent Application No. 2007-46969 filed on Feb. 27, 2007, which is herein incorporated by reference.

### BACKGROUND OF THE INVENTION

1. Technical Field

The present invention relates to a method of manufacturing a replica mold and a replica mold. More specifically, the present invention relates to a simple and inexpensive method of manufacturing a replica mold and a replica mold obtained by such method.

2. Description of the Related Art

A nanoimprint technology is known as a technique for forming minute pattern with a minute concavo-convex structure on a nanometer (nm) scale. General nanoimprint technologies are disclosed in the following documents, for example.

“Comparison of infrared frequency selective surfaces fabricated by direct-wire electron-beam and bilayer nanoimprint lithographies”, Irina Puscasu, G. Boreman, R. C. Tiberio, D. Spencer, and R. R. Krchnavek, J. Vac. Sci. Technol. B 18 3578 (2000)

“Nonlinear optical polymer patterned by nanoimprint lithography as a photonic crystal waveguide structure”, Motoki Okinaka, Shin-ichiro Inoue, Kazuhito Tsukagoshi, and Yoshinobu Aoyagi, J. Vac. Sci. Technol. B 24 271 (2006)

A typical procedure for forming a pattern using a nanoimprint technology is as follows: (1) applying a patterning material to a substrate; (2) pressing, onto the patterning material, a mold on which a predetermined minute pattern with a concavo-convex structure has been formed with a predetermined pressure, and promoting thermal deformation by heat treatment or ultraviolet curing by irradiation of ultraviolet rays; and (3) releasing the mold from the patterning material after a predetermined time, and then reversed minute pattern is obtained on the patterning material transferred from the mold. The nanoimprint technology has advantages in that the pattern formation can be performed using a much less expensive device as compared with a stepper for use in photolithography, and that maintenance of the device is easy.

On the other hand, a mold for use in the nanoimprint technology is required to have hardness and chemical resistance, and additionally heat resistance in case of a mold for thermal imprint, and ultraviolet ray transmittance in case for optical imprint. Moreover, a desired minute pattern depending on the purpose must be formed. Further, when forming of a laminate structure by nanoimprint, alignment is necessary between upper- and under-structure and that the mold needs to be transparent to a light source for alignment. From such viewpoints, molds are mostly obtained by precisely and finely processing on a quartz glass or silicon (e.g., dry etching using a metal mask). However, the conventional process for manufacturing the mold is very complicated, and as a result, the obtained mold becomes very expensive. Therefore, it is particularly preferable in view of economic aspects to use the mold as a master mold for manufacturing a replica mold.

From the above-mentioned viewpoints, a replica mold whose properties are equivalent to those of a master mold, and a simple and inexpensive method of manufacturing such replica mold are strongly desired.

### SUMMARY OF THE INVENTION

The present invention has been made in order to solve the above-mentioned conventional problems, and has an object to provide a replica mold which is excellent in transferring a pattern of a master mold, and also has notably excellent hardness, chemical resistance, heat resistance, and transparency in a visible region and an ultraviolet region, and a simple and inexpensive method of manufacturing such replica mold.

A method of manufacturing a replica mold according to an embodiment of the invention includes: applying, to a substrate, a replica mold material containing a polysilane and a silicone compound; pressing a master mold on which a predetermined minute pattern has been formed to the replica mold material which has been applied to the substrate; irradiating energy rays from a side of the substrate while the master mold is contacted by press with the replica mold material; releasing the master mold; and irradiating the replica mold material with energy rays from a side to which the master mold has been pressed.

In one embodiment of the invention, the method further includes irradiating oxygen plasma after the master mold has been released.

In another embodiment of the invention, the pressing is performed at about room temperature.

In still another embodiment of the invention, the pressing is performed with a pressure of 1 to 3 MPa.

In still another embodiment of the invention, the method further includes heating the replica mold material after irradiating the energy rays from the side to which the master mold has been pressed.

In still another embodiment of the invention, the heating is performed at 150 to 450° C.

In still another embodiment of the invention, the replica mold material has an application thickness larger than a height of the minute pattern formed on the master mold.

In still another embodiment of the invention, the method further includes heating the replica mold material before the pressing.

In still another embodiment of the invention, the energy rays include ultraviolet rays.

In still another embodiment of the invention, the irradiation of energy rays from the side to which the master mold has been pressed is performed in the presence of ozone.

In still another embodiment of the invention, the replica mold material contains the polysilane and the silicone compound at a weight ratio of 80:20 to 5:95.

In still another embodiment of the invention, the polysilane includes a branched polysilane.

In still another embodiment of the invention, the branched polysilane has a degree of branch of 2% or higher.

In still another embodiment of the invention, the replica mold material further contains a sensitizer.

In still another embodiment of the invention, the replica mold material further contains a metal oxide particle.

According to another aspect of the invention, a replica mold is provided. The replica mold is obtained by the above-described method.

In one embodiment of the invention, the replica mold has a plurality of minute patterns with different sizes ranging from 10 nm scale to 10 μm scale formed thereon.

In another embodiment of the invention, the replica mold has hardness of 300 HV or higher, light transmittance in a visible region of 90% or higher, and a light transmittance in an ultraviolet region with a wavelength of 300 nm of 70% or higher.

A replica mold according to another embodiment of the invention has a silicon dioxide structure derived from a polysilane and a silicone compound. The replica mold has: hardness of 300 HV or higher; a light transmittance in a visible region of 90% or higher; a light transmittance in an ultraviolet region with a wavelength of 300 nm of 70% or higher; and a plurality of minute patterns with different sizes ranging from 10 nm scale to 10 μm scale formed thereon.

According to the present invention, a pattern of a master mold can be transferred at low temperature, at low pressure, and in a short period of time by use of a replica mold material including a polysilane and a silicone compound and by irradiating energy rays by a specific procedure. As a result, a replica mold can be manufactured very simply and at low cost. Further, because a replica mold can be manufactured by a low-temperature process, thermal expansion and thermal contraction due to temperature changes during transferring are diminished to such an extent that thermal expansion and thermal contraction can be ignored, and a reversal replica mold faithful to a master mold can be obtained. In addition, by using the above-mentioned replica mold material, a replica mold which simultaneously satisfies extremely excellent hardness, transparency, heat resistance, and chemical resistance can be obtained.

### BRIEF DESCRIPTION OF THE DRAWINGS

In the accompanying drawings:

FIGS. 1A to 1E schematically illustrate a procedure of a method of manufacturing a replica mold according to a preferred embodiment of the present invention;

FIGS. 2A to 2D schematically illustrate a chemical change of polysilane incorporated in a replica mold material in the method of manufacturing a replica mold according to the preferred embodiment of the present invention; and

FIG. 3A is an SEM photograph of a minute pattern of the master mold used in the example of the present invention, and FIG. 3B is an SEM photograph of a minute pattern of a replica mold obtained in the example of the present invention.

### DETAILED DESCRIPTION OF THE PREFERRED EMBODIMENTS

Hereinafter, a replica mold material used in the present invention will be described. Then, a specific procedure of a method of manufacturing a replica mold will be described.

### A. Replica Mold Material

A replica mold material for use in the present invention includes a polysilane and a silicone compound. Generally, the replica mold material further includes a solvent. The replica mold material may optionally contain a suitable additive depending on the purpose. Typical examples of the additive include a sensitizer, a surface active agent, and metal oxide particles for adjusting the hardness.

### A-1. Polysilane

In this specification, the term “polysilane” refers to a polymer having a main chain consisting of only silicon atoms. The polysilane used in the present invention may be a straight chain type or a branched type. A branched polysilane is preferable. This is because the branched polysilane is excellent in solubility and compatibility with respect to a solvent or a silicone compound, and is also excellent in a film formation property. Polysilanes are classified into branched polysilanes and straight chain polysilanes depending on the bonding state of Si atoms incorporated in polysilanes. The branched polysilane refers to a polysilane which includes Si atoms in which the number of bonding to adjacent Si atoms is 3 or 4. In contrast, in a straight chain polysilane, the number of bonding in Si atoms is 2. Considering the fact that the valence of an Si atom is usually 4, the Si atoms whose bonding number is three or less among the Si atoms present in such a polysilane are bonded to a hydrogen atom or an organic substituent such as a hydrocarbon group and an alkoxy group in addition to an Si atom. Specific examples of preferable hydrocarbon groups include C₁₋₁₀ hydrocarbon groups which may be substituted with halogen and C₆₋₁₄ aromatic hydrocarbon groups which may be substituted with halogen. Specific examples of hydrocarbon groups include substituted or unsubstituted aliphatic hydrocarbon groups, such as a methyl group, an ethyl group, a propyl group, a butyl group, a hexyl group, an octyl group, a decyl group, a trifluoropropyl group, and a nonafluorohexyl group, and alicyclic hydrocarbon groups such as a cyclohexyl group and a methylcyclohexyl group. Specific examples of aromatic hydrocarbon groups include a phenyl group, a p-tolyl group, a biphenyl group, and an anthracenylgroup. Examples of an alkoxy group include C₁₋₈ alkoxy groups. Specific examples of C₁₋₈ alkoxy groups include a methoxy group, an ethoxy group, a phenoxy group, and an octyloxy group. Of those, in view of easiness in synthesis, a methyl group and a phenyl group are particularly preferable. For example, polymethylphenylsilane, polydimethylsilane, polydiphenylsilane, and a copolymer thereof can be preferably used. For example, the refractive index of a pattern or an optical element to be obtained can be adjusted by changing the structure of polysilane. Specifically, when a high refractive index is desired, a large amount of diphenyl groups may be incorporated during copolymerization, and when a low refractive index is desired, a large amount of dimethyl groups may be incorporated during copolymerization.

In branched polysilanes, the degree of branch is preferably 2% or more, more preferably 5 to 40%, and particularly preferably 10 to 30%. When the degree of branch is less than 2%, the solubility is low and microcrystals, which are likely to be generated in a film to be obtained, cause scattering, resulting in insufficient transparency in many cases. When the degree of branch is excessively high, polymerization of a polymer having large molecular weight may become difficult, and absorption in a visible region may become large due to the branching. In the above-mentioned preferable range, optical transmittance can be increased as the degree of branch is higher. In this specification, the phrase “the degree of branch” refers to a proportion of the Si atoms whose bonding number with adjacent Si atoms is 3 or 4 in all Si atoms of a branched polysilane. In this specification, for example, the phrase “the bonding number with adjacent Si atoms is 3” refers to a case where three bonding hands of an Si atom are bonded to Si atoms.

The polysilane used in the present invention can be produced by a polycondensation reaction in which a halogenated silane compound is heated to 80° C. or higher in an organic solvent such as n-decane or toluene in the presence of an alkaline metal such as sodium. Moreover, the polysilane used in the present invention can also be synthesized by an electrolytic polymerization method or a method using magnesium metal and metal chloride.

A branched polysilane is obtained by heating a halosilane mixture including an organotrihalosilane compound, a tetrahalosilane compound, and a diorganodihalosilane compound for polycondensation. The degree of branch of a branched polysilane can be controlled by adjusting the amount of the organotrihalosilane compound and the tetrahalosilane compound in the halosilane mixture. For example, by the use of a halosilane mixture in which the proportion of an organotrihalosilane compound and a tetrahalosilane compound is 2 mol % or more with respect to the total amount, a branched polysilane whose degree of branch is 2% or more can be obtained. In such a case, an organotrihalosilane compound serves as a source of an Si atom whose bonding number with adjacent Si atoms is 3, and a tetrahalosilane compound serves as a source of an Si atom whose bonding number with adjacent Si atoms is 4. The branch structure of a branched polysilane can be confirmed by measuring an ultraviolet absorption spectrum or the nuclear magnetic resonance spectrum of silicon.

The halogen atom of each of the above-mentioned organotrihalosilane compound, tetrahalosilane compound, and diorganodihalosilane compound is preferably a chlorine atom. Examples of substituents other than the halogen atom of the organotrihalosilane compound and diorganodihalosilane compound include the above-mentioned hydrogen atom, hydrocarbon group, alkoxy group, and functional group.

There is no limitation on the above-mentioned branched polysilane insofar as they are soluble in an organic solvent, compatible with a silicone compound, and form a transparent film when being applied.

At least one part of polysilane may be fluorinated depending on the purpose. By appropriately performing such denaturation, a replica mold whose surface energy is small and which eliminates the necessity of using a mold release agent can be obtained.

The weight average molecular weight of the above-mentioned polysilane is preferably 5,000 to 50,000 and more preferably 10,000 to 20,000.

The above-mentioned polysilane may contain a silane oligomer, if required. The content of silane oligomer in the polysilane is preferably 5 to 25% by weight. By containing a silane oligomer in the above-mentioned range, a press contact process can be performed at lower temperature. When the oligomer content exceeds 25% by weight, flowage and disappearance of a pattern may occur in a heating process.

The weight average molecular weight of the above-mentioned silane oligomer is preferably 200 to 3,000 and more preferably 500 to 1,500.

### A-2. Silicone Compound

As a silicone compound used in the present invention, any appropriate silicone compound which is compatible with a polysilane and an organic solvent and which can form a transparent film can be used. In one embodiment, a silicone compound is a compound represented by the following general formula:

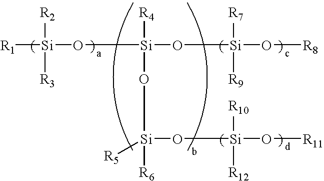

where R₁ to R₁₂ each independently represents C₁₋₁₀ hydrocarbon groups which may be substituted with a halogen or glycidyloxy group, C₆₋₁₂ aromatic hydrocarbon groups which may be substituted with a halogen or glycidyloxy group, or C₁₋₈ alkoxy groups which may be substituted with a halogen or glycidyloxy group, and a, b, c, and d are integers including 0 and satisfy a+b+c+d≧1.

A specific example thereof includes a silicone compound obtained by hydrolysis condensation of two or more kinds of dichlorosilane referred to as a D isomer, which has two organic substituents, and trichlorosilane referred to as T isomers, which has one organic substituent.

Specific examples of the hydrocarbon groups include substituted or unsubstituted aliphatic hydrocarbon groups such as a methyl group, a propyl group, a butyl group, a hexyl group, an octyl group, a decyl group, a trifluoropropyl group, and a glycidyloxypropyl group, and alicyclic hydrocarbon groups such as a cyclohexyl group and a methyl cyclohexyl group. Specific examples of the above-mentioned aromatic hydrocarbon groups include a phenyl group, a p-tolyl group, and a biphenyl group. Specific examples of the above-mentioned alkoxy groups include a methoxy group, an ethoxy group, a phenoxy group, an octyloxy group, and a tert-butoxy group.

The kinds of R₁ to R₁₂ and the values of a, b, c, and d may be appropriately determined depending on the purpose. For example, compatibility can be improved by incorporating, into a silicone compound, a group same as the hydrocarbon group incorporated in a polysilane. Therefore, when using, for example, a phenylmethyl polysilane as a polysilane, it is preferable to use a phenylmethyl silicone compound or a diphenyl silicone compound. Moreover, for example, a silicone compound which has two or more alkoxy groups in one molecule (specifically, a silicone compound in which at least two groups of R₁ to R₁₂ are C₁₋₈ alkoxy groups) can be used as a crosslinking agent. Specific examples of such a silicone compound include a methylphenyl methoxy silicone and phenylmethoxy silicone which include an alkoxy group in a proportion of 15 to 35% by weight. In this case, the content of the alkoxy group can be calculated from the average molecular weight of the silicone compound and the molecular weight of an alkoxy unit.

The weight average molecular weight of the above-mentioned silicone compound is preferably 100 to 10,000, and more preferably 100 to 3,000.

In one embodiment, a silicone compound contains, if required, a double bond-containing silicone compound. The content of the double bond-containing silicone compound in a silicone compound is preferably 20 to 100% by weight, and more preferably 50 to 100% by weight. By using a double bond-containing silicone compound in the above-mentioned range, the reactivity at the time of the irradiation of energy rays is improved, and press contact at lower temperature and processing at lower irradiation can be achieved. Moreover, when the content of a silicone compound is higher than that of a polysilane, flowage and disappearance of a pattern at the time of a heat treatment due to reduced solidity can be prevented.

The weight average molecular weight of the double bond-containing silicone compound is preferably 100 to 10,000, and more preferably 100 to 5,000.

A chemical group providing a double bond in the above-mentioned double bond-containing silicone compound is preferably a vinyl group, an allyl group, an acryloyl group, or a methacryloyl group. For example, among silicone compounds commonly referred to as a silane coupling agent, silicone compounds having a double bond can be used. In this case, the iodine value is preferably 10 to 254. The number of double bonds in one molecule of a silicone compound may be two or more. Such a silicone compound can be used as a crosslinking agent. Specific examples of such a silicone compound include a vinyl group-containing methylphenyl silicone resin which includes 1 to 30% by weight of a double bond.

A commercially available double bond-containing silicone compound can be used as the double bond-containing silicone compound. For example, compounds shown in the following Table 1 can be used.

TABLE 1

| Double | | | | |
|---|---|---|---|---|
| bond | Manufacturer | Tradename | Kind of silicone compound | Mw |
| Vinyl | Shinetsu Silicone | KBM-1003 | Vinyl trimethoxy silane | 148.2 |
| | Shinetsu Silicone | KBE-1003 | Vinyl triethoxy silane | 190.3 |
| | Shinetsu Silicone | KR-2020 | Vinyl group-containing phenylmethyl | 2,900 |
| | | | silicone resin | |
| | Shinetsu Silicone | X-40-2667 | Vinyl group-containing phenylmethyl | 2,600 |
| | | | silicone resin | |
| | Dow Corning Toray | SZ-6300 | Vinyl trimethoxy silane | |
| | Dow Corning Toray | SZ-6075 | Vinyl triacethoxy silane | |
| | Dow Corning Toray | CY52-162 | Vinyl group containing silicone resin | |
| | Dow Corning Toray | CY52-190 | Vinyl group containing silicone resin | |
| | Dow Corning Toray | CY52-276 | Vinyl group containing silicone resin | |
| | Dow Corning Toray | CY52-205 | Vinyl group containing silicone resin | |
| | Dow Corning Toray | SE1885 | Vinyl group containing silicone resin | |
| | Dow Corning Toray | SE1886 | Vinyl group containing silicone resin | |
| | Dow Corning Toray | SR-7010 | Vinyl group-containing phenylmethyl | |
| | | | silicone resin | |
| | GE Toshiba Silicone | TSL8310 | Vinyl trimethoxy silane | |
| | GE Toshiba Silicone | TSL8311 | Vinyl triethoxy silane | |
| | GE Toshiba Silicone | XE5844 | Vinyl group-containing phenylmethyl | |
| | | | silicone resin | |
| Methacryloyl | Shinetsu Silicone | KBM-502 | 3-methacryloxypropylmethyldimethoxy | 232.4 |
| | | | silane | |
| | Shinetsu Silicone | KBM-503 | 3-methacryloxypropyltrimethoxy | 248.4 |
| | | | silane | |
| | Shinetsu Silicone | KBE-502 | 3-methacryloxypropylmethyldiethoxy | 260.4 |
| | | | silane | |
| | Shinetsu Silicone | KBE-503 | 3-methacryloxypropyltriethoxy | 290.4 |
| | | | silane | |
| | GE Toshiba Silicone | SZ-6030 | γ-methacryloxypropyltrimethoxy | |
| | | | silane | |
| | GE Toshiba Silicone | TSL8370 | γ-methacryloxypropyltrimethoxy | |
| | | | silane | |
| | GE Toshiba Silicone | TSL8375 | γ-methacryloxypropylmethyldimethoxy | |
| | | | silane | |
| Acryloyl | Shinetsu Silicone | KBM-5103 | 3-acryloxypropyltrimethoxy silane | 234.3 |

The above-mentioned silicone compound(s) is incorporated in a replica mold material in such a manner that the weight ratio of polysilane to silicone compound is preferably 80:20 to 5:95, and more preferably 70:30 to 40:60. By containing the silicone compound(s) in the above-mentioned range, a replica mold which is sufficiently cured (i.e., notably excellent in hardness), which has very few cracks, and which has high transparency can be obtained.

### A-3. Solvent

The above-mentioned replica mold material generally contains a solvent. An organic solvent is preferable as a solvent. Preferable organic solvents include C₅₋₁₂ hydrocarbon solvents, halogenated hydrocarbon solvents, and ether solvents. Specific examples of hydrocarbon solvents include: aliphatic solvents such as pentane, hexane, heptane, cyclohexane, n-decane, and n-dodecane; and aromatic solvents such as benzene, toluene, xylene, and methoxy benzene. Specific examples of halogenated hydrocarbon solvents include carbon tetrachloride, chloroform, 1,2-dichloro ethane, dichloromethane, and chlorobenzene. Specific examples of ether solvents include diethyl ether, dibutyl ether, and tetra hydrofuran. The amount of the solvent used is adjusted in such a manner that the polysilane concentration in a replica mold material is in the range of 10 to 50% by weight.

### A-4. Sensitizer

Preferably, the above-mentioned replica mold material may further contain a sensitizer. A typical example of a sensitizer includes an organic peroxide. Any compounds, which can efficiently incorporate oxygen between an Si—Si bond of a polysilane, can be employed as the organic peroxides. Examples thereof include a peroxyester peroxide and an organic peroxide having a benzophenone structure. More specifically, 3,3′,4,4′-tetra(t-butylperoxycarbonyl)benzophenone (hereinafter, referred to as “BTTB”) is used preferably. Moreover, an organic peroxide acts on a double bond of a double bond-containing silicone compound to promote an addition polymerization reaction between double bonds.

The above-mentioned sensitizer is used in a proportion of preferably 1 to 30 parts by weight, and more preferably 2 to 10 parts by weight with respect to a total amount of 100 parts by weight of the above-mentioned polysilane and silicone compound. By using a sensitizer in the above-mentioned range, oxidation of a polysilane is promoted even under a non-oxidative atmosphere, and a replica mold having notably excellent hardness can be formed at low temperatures, low pressures, and in a short period of time.

### A-5. Surface Active Agent

A specific example of the surface active agent includes a fluorine surfactant. A surface active agent may be preferably used in a proportion of 0.01 to 0.5 parts by weight with respect to a total amount of 100 parts by weight of the above-mentioned polysilane and silicone compound. By using the surface active agent, the application property of a replica mold material can be improved.

### A6. Metal Oxide Particles

As the metal oxide particles, any appropriate particles may be used insofar as the effect of the present invention can be achieved. Specific examples of metals which form a metal oxide include lithium (Li), copper (Cu), zinc (Zn), strontium (Sr), barium (Ba), aluminum (Al), yttrium (Y), indium (In), cerium (Ce), silicon (Si), titanium (Ti), zirconium (Zr), tin (Sn), niobium (Nb), antimony (Sb), tantalum (Ta), bismuth (Bi), chromium (Cr), tungsten (W), manganese (Mn), iron (Fe), nickel (Ni), ruthenium (Ru), and alloys thereof. The composition of oxygen in a metal oxide is determined according to the valence of metal. In the present invention, zircon oxide, titanium oxide, and/or zinc oxide may be preferably used as a metal oxide. By using such metal oxide, a replica mold having notably excellent hardness can be obtained.

The average particle diameter of the above-mentioned metal oxide particles is preferably 1 to 100 nm, and more preferably 1 to 50 nm. By using the metal oxide particles having average particle diameter in the above-mentioned range, a replica mold having extremely excellent hardness and transparency can be obtained.

The above-mentioned metal oxide particles are contained in a replica mold material in a proportion of preferably 50 to 500 parts by weight, and more preferably 100 to 300 parts by weight with respect to 100 parts by weight of the above-mentioned polysilane. By containing metal oxide particles in the above-mentioned range, a replica mold with desired hardness can be obtained, and also such a replica mold has outstanding film formation properties at the time of manufacturing and/or pattern formation.

The above-mentioned metal oxide particles can be obtained using any appropriate methods. For example, the above-mentioned metal oxide particles can be formed by wet process, burning, etc. Moreover, commercially available metal oxide particles may be used as the above-mentioned metal oxide particles. A specific example of commercially available metal oxide particles includes nano zirconia dispersion NZD-8J61 (tradename) manufactured by Sumitomo Osaka Cement Co., Ltd. Metal oxide particles are provided in the form of dispersion in one embodiment. In this case, typically, a replica mold material may be prepared by adding, under stirring, another ingredient to a dispersion of metal oxide particles. In another embodiment, metal oxide particles may be provided in non-dispersed form (substantially in the form of particles). In this case, metal oxide particles are dispersed in another ingredient of a replica mold material, and the solid content of the replica mold material can be adjusted using a solvent and the like to be described later. In each embodiment, a dispersant is suitably used.

In the present invention, for example, hard particles whose hardness is 500 HV or more can be used beside the above-mentioned metal oxide particles. SiC particles and SiN particles are mentioned as an example of such hard particles.

### B. Method of Manufacturing a Replica Mold

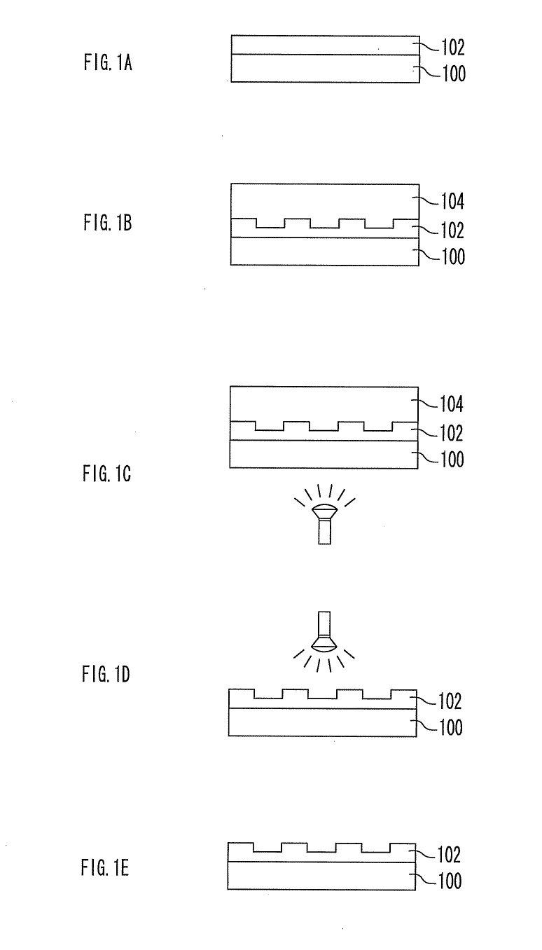

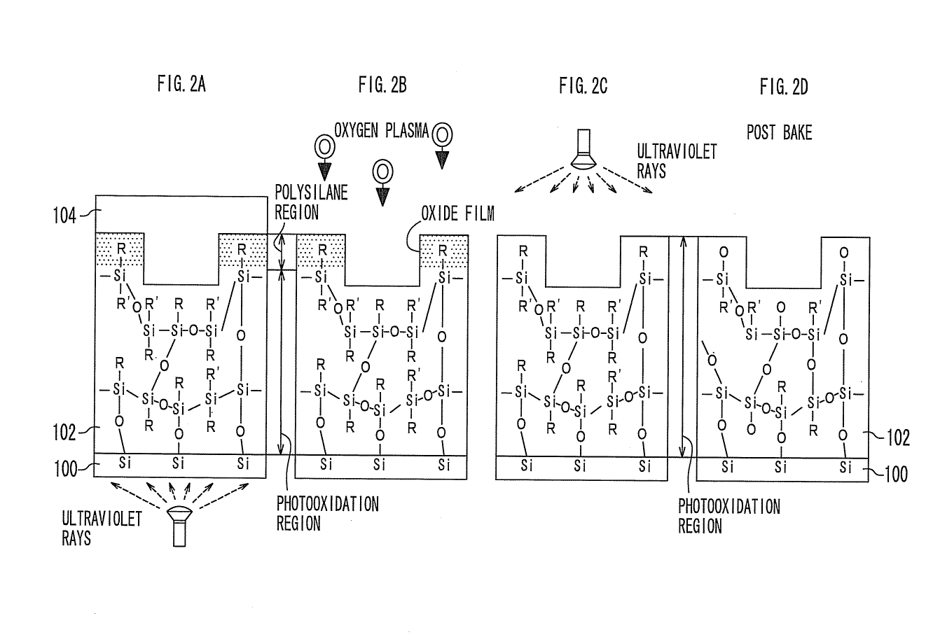

With reference to the drawings, a method of manufacturing a replica mold according to an embodiment of the present invention will be described. FIGS. 1A to 1E schematically illustrate a procedure of a method of manufacturing a replica mold according to a preferred embodiment of the present invention. FIGS. 2A to 2D schematically illustrate the chemical change of a polysilane incorporated in a replica mold material.

First, as shown in FIG. 1A, a replica mold material 102 described in the section A is applied to a substrate 100. As a substrate, any appropriate substrate through which energy rays can pass may be used. A typical example of a substrate includes a quartz substrate in the case of using ultraviolet rays as energy rays. Any appropriate application method may be adopted as a method for the application of a replica mold material. Spin coating is mentioned as a typical example. The application thickness of a replica mold material is preferably larger than the height of a minute pattern part of a master mold. For example, when the height of the minute pattern part of the master mold is 1.0 μm, the application thickness of the replica mold material is preferably about 1.1 to about 2.0 μm. The application thickness of the replica mold material can be controlled by adjusting the concentration of the replica mold material and the speed of rotation (rpm) of a spin coater.

Next, as shown in FIG. 1B, a master mold 104 on which a predetermined minute pattern has been formed depending on the purpose is contacted by press with the replica mold material 102 which has been applied to the substrate 100. Press contact (also referred to as “pressing” in this specification) is preferably performed at about room temperature. Press contact at about room temperature can be achieved by using the above-mentioned replica mold material and performing a series of processes to be described later. Because the press contact at about room temperature can minimize a period of time required for raising and lowering temperature, processing time of a nanoimprint process (specifically, a pattern transfer process from a master mold) can be dramatically reduced. Further, the merit of press contact at about room temperature resides in that because expansion and contraction due to temperature changes under press contact becomes so small that they can be ignored, deformation of the minute pattern formed on the replica mold with respect to a master mold can be favorably avoided. It is one of the achievements of the present invention that such press contact at about room temperature is realized. In one embodiment, press contact temperature is in the range of room temperature to 80° C., contact pressure is 1 MPa to 3 MPa, and a press contact time is 5 seconds to 15 seconds. According to the present invention, nanoimprint (specifically, pattern transfer from a master mold) at low temperatures and low pressures, and in a short period of time as described above becomes possible. In the present invention, it is desirable that a replica mold material be heat-treated before press contact (so-called prebaking treatment). As conditions for the prebaking treatment, a heating temperature is 50 to 100° C., and a heating duration is 3 to 7 minutes, for example.

The above-mentioned master mold 104 is preferably formed of an energy ray transmittable material, and is more preferably formed of a light transmittable material for alignment of a master mold and a replica mold. A specific example of a material which forms a master mold includes quartz glass or an Si substrate having excellent processability.

Next, as shown in FIG. 1C, under a state where the master mold 104 and the replica mold material 102 are contacted by press, energy rays (typically ultraviolet rays to be described later) are irradiated. As a result, an Si—Si bond in a polysilane in the replica mold material is converted into an Si—O—Si bond, causing vitrifying of the replica mold material. As a result, the minute pattern formed on the master mold is transferred to the replica mold material, and the pattern is fixed. Energy rays are irradiated from the substrate 100 side. By performing the energy ray irradiation from the substrate 100 side, oxidation (typically photooxidation) of the entire replica mold material can be advanced until the mold pattern is firmly fixed as shown in FIG. 2A. Moreover, when using, for example, a quartz substrate, regarding the replica mold material in the vicinity of the substrate 100, an Si—O—Si bond is also formed between Si atoms of the substrate and the replica mold material, and therefore very firm adherence can be achieved. As shown in FIG. 2A, by selecting an appropriate light irradiation amount for the replica mold material in the vicinity of the master mold 104, progress of oxidation (typically photooxidation) can be inhibited and an outstanding mold-release property between the master mold and the replica mold material can be secured. As a result of leaving a portion which is not photo-oxidized at the interface between the master mold and the replica mold material, the master mold and the replica mold material are not adhered to each other and the replica mold material can be released from the master mold. Therefore, a replica mold can be formed with a very high yield.

Typical examples of the above-mentioned energy rays include light (visible light, infrared rays, ultraviolet rays), electron beam, and heat. Ultraviolet rays are preferable in the present invention. Ultraviolet rays whose wavelength spectrum peak is 365 nm or less are preferable. Specific examples of a source of ultraviolet rays include an ultra-high pressure mercury lamp and a halogen lamp. In one embodiment, when the application thickness of a replica mold material is about 2 μm, the replica mold material is irradiated with ultraviolet rays whose level emission intensity is 105 μW/cm (wavelength λ=360 nm to 370 nm) for about 3 minutes, thereby vitrification of the replica mold material can be performed.

Next, the master mold 104 is released from the replica mold material 102. As described above, because the oxidation of the replica mold material in the vicinity of the master mold is inhibited moderately, release of the master mold is very easy. Therefore, pattern missing at the time of mold releasing and fall of the yield can be notably inhibited. In addition, as shown in FIG. 1D, when the master mold is released, the replica mold is formed sufficiently favorably in terms of appearance.

As required, the replica mold material (replica mold that is sufficiently formed in terms of appearance) 102 may be irradiated with oxygen plasma. By the irradiation of oxygen plasma, a sufficient amount of oxygen is supplied to the surface of a replica mold material, which has not been completely oxidized. As a result, as shown in FIG. 2B, a hard oxide film is formed on the surface. Thus, deformation of the minute pattern formed on the replica mold is favorably avoided. The thickness of the oxide film formed by plasma treatment is 2 to 3 nm, for example. The irradiation conditions of oxygen plasma are, for example, as follows: oxygen flow of 800 cc, chamber pressure of 10 Pa, irradiation time of 1 minute, and output of 400 W.

Next, as shown in FIG. 1D, the replica mold material (replica mold that is sufficiently formed in terms of appearance) 102 is irradiated with energy rays (typically ultraviolet rays) from the side opposite to the substrate 100 (i.e., side to which the master mold 104 has been contacted by press). By the irradiation of ultraviolet rays, photooxidation of the replica mold material in the vicinity of the patterned surface is completed substantially, and the surface of the pattern is sufficiently oxidized (refer to FIG. 2C). In one embodiment, ultraviolet rays may be irradiated in the presence of ozone. By irradiating ultraviolet rays in the presence of ozone, not only that photooxidation reaction caused by the irradiation of ultraviolet rays can be progressed but also the chemical oxidation reaction caused by ozone can be progressed. Thus, oxidation of an unreacted portion of the pattern surface can be favorably completed.

Preferably, after the irradiation of energy rays from the master mold side described above, a heat-treatment (so-called post bake process) can be further performed. By performing a post bake process, oxidation reaction of a polysilane due to heat (thermal oxidation) occurs in addition to the above-mentioned oxidation reaction (photooxidation) of a polysilane by the irradiation of ultraviolet rays. As a result, oxidation of a polysilane is further progressed and vitrification of a polysilane is achieved as a polysilane to have extremely excellent hardness (refer to FIGS. 1E and 2D). In one embodiment, the conditions of the post bake process are as follows: a heating temperature being preferably 150 to 450° C. and heating duration being 3 to 10 minutes. The heating temperature may vary depending on the purpose. For example, chemical resistance may be imparted to the replica mold to be obtained by post baking at 150 to 200° C. It is one of the achievements of the present invention to realize such a post bake process at significantly low temperatures. Moreover, by post baking at 400° C., for example, a replica mold which has a Vickers hardness comparable to low-melting point glass can be obtained.

Practically, a mold release agent is applied to the replica mold surface using a silane coupling agent and the like. In general, with respect to the minute pattern formed on the replica mold, the surface area increases due to the minute pattern, and thus a patterning material to be transferred is easily adhered. In order to prevent this, it is desirable to adhere onto the mold surface a silane coupling agent which includes a CF₃ group for lowering surface energy. As a method of applying a mold release agent, there are vacuum deposition and dipping in a coupling agent, for example. Dipping is preferable because the mold release agent is firmly bonded to the mold surface. Moreover, because the pattern of the replica mold is on a nanometer scale, the film thickness of a mold release agent is preferably approximately the same as the thickness of a single molecular film (several nanometers). As a specific procedure of applying a mold release agent, there is the following procedure, for example. Pollutants, dust, etc. are removed from the mold surface using chemicals such as acetone. Then, a mold replica is rendered into an SiO₂ clean surface with a UV ozone cleaner, etc. Subsequently, the resultant is subjected to dipping for 5 minutes in a trichloro(1H, 1H,2H,2H-perfluorooctyl)silane solution of about 1%, thereby applying a mold release agent.

A replica mold is obtained as described above.

### C. Replica Mold

The replica mold of the present invention has a silicon dioxide structure derived from a polysilane contained in the above-mentioned replica mold material and a silicone compound. This replica mold has the equivalent hardness and transparency to that of usual glass. The hardness of the replica mold of the present invention is preferably 300 HV or more, more preferably 450 HV or more, and still more preferably about 800 HV. Further, when the replica mold is used for optical alignment, the light transmittance is preferably 90% or higher in a visible region, and when the replica mold is used for UV imprint, the light transmittance is preferably 70% or higher in a UV region. Preferably, the optical transmittance of the replica mold of the present invention is 90% or higher in a visible region, and is 70% or higher in a UV region.

It is preferable that the replica mold of the present invention have a heat resistance such that the height ratio of the pattern is substantially the same before and after a heat treatment at 250° C. for 5 minutes. It is preferable that the replica mold of the present invention have a heat resistance such that the change in the pattern height before and after the heat-treatment at 350° C. for 5 minutes is within ±5%. Further, the replica mold of the present invention has extremely outstanding chemical resistance. More specifically, the replica mold of the present invention has very high tolerance to any of organic solvents, strong acids, and strong bases. For example, the replica mold of the present invention can almost completely maintain the pattern shape after being subjected to ultrasonic cleaning in acetone for 5 minutes. Moreover, for example, the replica mold of the present invention can almost completely maintain the pattern shape after being immersed in HCl, HF, or NaOH for 30 minutes.

Preferably, the replica mold of the present invention has two or more minute patterns with different sizes ranging from 10 nm scale to 10 μm scale. Because the above-mentioned replica mold material has notably excellent pattern transferring property of a master mold, patterns with various sizes which differ by three orders of magnitude can be formed at one time. For example, a line and space (L&S) patterns whose line width and line interval are 50 nm to 25 μm can be formed at one time.

As described above, the replica mold of the present invention can simultaneously satisfy a pattern transferring property, hardness, transparency (light transmittance in a visible region and UV region), heat resistance, and chemical resistance. In addition, as described in the section B, the replica mold of the present invention can be manufactured very simply and at low cost by a process carried out at low temperatures and low pressures, and in a short period of time. It is one of the big achievements of the present invention to actually obtain a replica mold imparted with all of those properties.

### D. Industrial Applicability

The replica mold of the present invention can be suitably used for UV and thermal nanoimprint technologies.

Hereinafter, the present invention will be described in more detail with reference to Examples, but the present invention is not limited thereto.

### Reference Example 1

### Synthesis of a Polysilane

Four hundred ml of toluene and 13.3 g of sodium were charged in a 1000-ml flask equipped with a stirrer. The temperature of the contents of this flask was raised to 111° C. and stirred at high speed in a yellow room which shielded ultraviolet rays, thereby finely dispersing sodium in toluene. Phenylmethyldichlorosilane 42.1 g and 4.1 g of tetrachlorosilane were added thereto, followed by stirring for 3 hours for polymerization. Then, ethanol was added to the reaction mixture obtained to deactivate excessive sodium. The resultant was washed with water, and then the separated organic layer was put in ethanol to thereby precipitate a polysilane. By re-precipitating the obtained crude polysilane 3 times in ethanol, a branched polymethylphenylsilane having weight average molecular weight of 11,600 and including 10% of oligomer was obtained.

### Reference Example 2

### Synthesis of Fluorine-Containing Polysilane

The procedure was carried out in the same manner as in Reference Example 1 except that 25.8 g of phenylmethyldichlorosilane and 28.5 g of methyltrifluoropropyldichlorosilane were used in place of phenylmethyldichlorosilane, to thereby give phenylmethyl/methyltrifluoropropyl (1/1) copolysilane having a weight average molecular weight of 10,000 and including 10% of oligomer.

### Reference Example 3

### Preparation of a Replica Mold Material

The polymethylphenylsilane (PMPS) obtained in Reference Example 1, phenylmethyl/methyltrifluoropropyl (1/1) copolysilane (PMTFPCPS) obtained in Reference Example 2, vinyl group-containing phenylmethylsilicone resin (tradename “KR-2020”, Mw=2,900, iodine value=61), methoxy group-containing phenylmethyl silicone resin not containing a double bond (tradename “DC-3074”, manufactured by Dow Corning Corporation), and an organic peroxide BTTB (manufactured by Nippon Oil & Fats Co., Ltd., 20% by weight of solid content) were mixed in proportions shown in Table 2. The resultant mixture was dissolved in methoxybenzene (tradename “anisole S”, manufactured by KYOWA HAKKO KOGYO Co., Ltd.) in such a manner that the solid content was 77% by weight, to thereby prepare replica mold materials Nos. 1 to 7. In the replica mold material No. 7, zirconia oxide nanoparticle dispersion (manufactured by Sumitomo Osaka Cement, Inc., tradename “NZD-8J61”, 16% of solid content) was used in combination with the above-mentioned materials.

TABLE 2

| | Content (% by weight) | | | | | |
|---|---|---|---|---|---|---|
| Replica mold | | | NZD- | KR- | | |
| material No. | PMPS | PMTFPCPS | 8J61 | 2020 | DC-3074 | BTTB |
| 1 | 67 | 0 | 0 | 33 | 0 | 5 |
| 2 | 50 | 0 | 0 | 50 | 0 | 3.8 |
| 3 | 40 | 0 | 0 | 60 | 0 | 3 |
| 4 | 67 | 0 | 0 | 0 | 33 | 3 |
| 5 | 67 | 0 | 0 | 16.5 | 16.5 | 3 |
| 6 | 0 | 67 | 0 | 0 | 33 | 3 |
| 7 | 67 | 0 | 95 | 0 | 33 | 3 |

### Example 1

A 5 mm×5 mm sample piece was cut out from a quartz substrate, sufficiently washed, and used as a substrate. Washing was performed by subjecting the sample piece to ultrasonic cleaning in acetone for 3 minutes, and leaving the resultant to stand for 10 minutes in a UV ozone cleaner. Replica mold material No. 1 obtained in Reference Example 3 was spin-coated onto the substrate surface for 40 seconds at 2,500 rpm to thereby obtain a coating film with a thickness of about 2 μm. The substrate to which the replica mold material was applied was prebaked at 80° C. for 5 minutes.

Subsequently, a master mold made of Si on which line and space (L&S) patterns with a plurality of different sizes were formed was pressed against the above-mentioned coating film for 10 seconds at 80° C. at a pressure of 2 MPa for imprinting. In the L&S patterns of the master mold used in this example, a line to space ratio L:S was 1:1 and a line (space) size was 250 nm to 25 μm, which differs by two orders of magnitude. Further, ultraviolet rays were irradiated (light source: an ultra-high pressure mercury lamp, output: 250 W, and irradiation time: about 3 minutes) from the substrate side while pressing the master mold against the coating film, whereby the coating film was almost completely photooxidized. Subsequently, the master mold was pulled up vertically and released. On the surface of the coating film (replica mold) after the master mold was released, the pattern of the master mold was favorably reversely transferred.

Further, oxygen plasma treatment was performed to the replica mold surface. The conditions of oxygen plasma treatment were as follows: oxygen flow of 800 cc, chamber pressure of 10 Pa, irradiation time of 1 minute, and output of 400 W. Next, ultraviolet rays were irradiated from the pattern surface side of the replica mold (side to which the master mold was pressed). This ultraviolet irradiation was performed in the presence of ozone using a UV ozone cleaner. In this process, ultraviolet irradiation was performed for 30 minutes at oxygen flow of 0.5 L/min. Finally, the replica mold obtained as described above was postbaked on a hot plate at 400° C. for 5 minutes. The replica mold was obtained as described above.

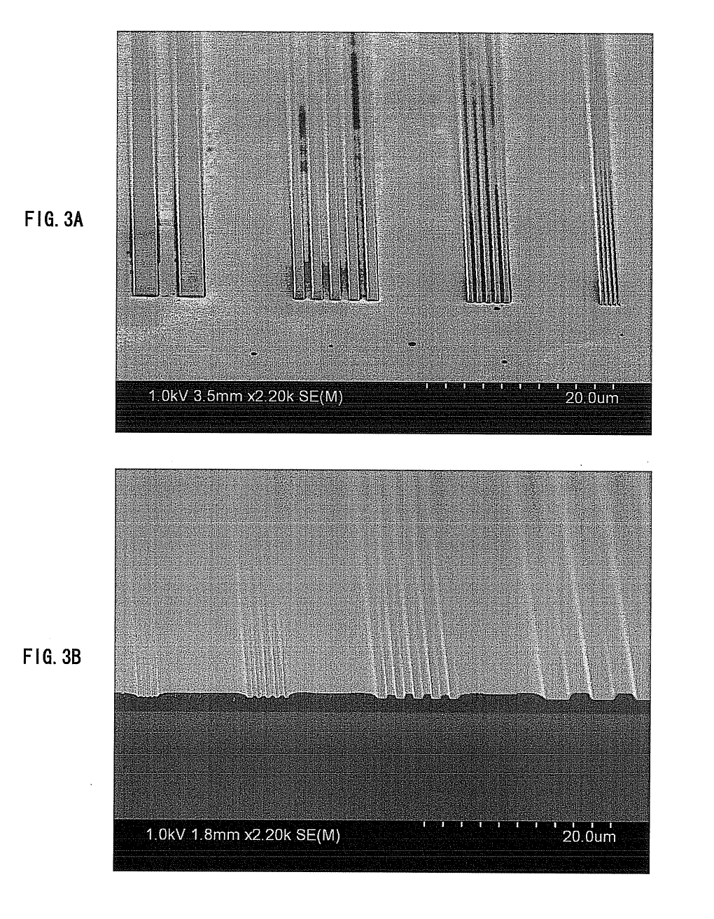

The minute pattern of the obtained replica mold was observed with a scanning electron microscope (SEM). The results are shown in FIGS. 3A and 3B. FIG. 3A is an SEM photograph of the minute pattern of the master mold used in the example of the present invention. FIG. 3B is an SEM photograph of the minute pattern of the replica mold obtained in the example of the present invention. As is apparent from FIGS. 3A and 3B, the L&S patterns with a line (space) size of 250 nm to 2.5 μm were favorably imprinted at one time. Further, it was confirmed that the L&S patterns with a line (space) size of 50 nm to 25 μm were favorably transferred under the same conditions as described above, thereby succeeding in collectively forming structures whose sizes differ by about three orders of magnitude. Thus, according to the method of manufacturing the replica mold of the present invention, it was found that the pattern of the master mold can be amazingly favorably transferred onto the replica mold at low temperatures and low pressures, and in a short period of time. Moreover, since low-temperature processing was achieved, a time required for the entire process was notably shortened compared with the conventional process. As a result, the replica mold can be manufactured very simply at low cost.

The surface of the obtained replica mold was washed with acetone to remove pollutants, dust, etc. Subsequently, a mold replica was rendered into a SiO₂ clean surface with a UV ozone cleaner. Then, the resultant was subjected to dipping for 5 minutes in a trichloro(1H,1H,2H,2H-perfluorooctyl)silane solution of about 1%, thereby applying a mold release agent. After dipping, a firm bond with the replica mold was formed by a heat treatment at 180° C. Finally, in order to remove excessive mold release agents, ultrasonic cleaning was performed in acetone for 1 minute.

Further, the obtained replica molds were evaluated for their properties based on the following evaluation items.

### (1) Heat Resistance

The obtained replica mold was heated on a hot plate, and the ratio of the height of the pattern before and after the heat treatment was set as a heat-resistance index. The ratio of the height of the pattern of the replica mold obtained in this example after the heat treatment at 250° C. for 5 minutes was 1 (i.e., no deformation was confirmed before and after the heat treatment). Further, the ratio of the height of the pattern after the heat treatment at 350° C. for 5 minutes was 0.95 (thermal contraction was 5%). Thus, the replica mold obtained in this example showed outstanding heat resistance.

### (2) Mechanical Properties

Micro Vickers hardness was measured as a mechanical property index. The Vickers hardness of the replica mold obtained in this example was 310 HV, which was about 3 times as hard as that of PMMA. Thus, the replica mold obtained in this example showed an excellent mechanical property (hardness).

### (3) Light Transmittance and Transparency

Transmittance was measured by a usual method. As a result, the visible light transmittance of the replica mold obtained in this example was about 90% or higher, and the transmittance of deep ultraviolet rays with a wavelength of 300 nm was 70% or higher. Thus, the replica mold obtained in this example had excellent light transmittance not only in a visible region but also in a deep ultraviolet region. Thus, it was confirmed that the replica mold obtained in this example can be suitably used also as a mold replica for UV imprints.

### (4) Chemical Resistance

The obtained replica mold was subjected to ultrasonic cleaning in acetone for 5 minutes. The replica mold obtained in this example almost completely maintained the shape even after the ultrasonic cleaning.

Moreover, the obtained replica mold was immersed in each of an aqueous 10% HCl solution, an aqueous 10% NaOH solution, and an aqueous 5% HF solution for 30 minutes. As a result, the replica mold obtained in this example almost completely maintained the shape even after any of the solution treatments. Thus, the replica mold obtained in this example had remarkably excellent chemical resistance. A mold is required to have excellent chemical resistance in order to avoid adhesion of the patterning material. The mold obtained in this example was confirmed to satisfy the requirement.

### (5) Aspect Ratio

The aspect ratio was analyzed from an SEM photograph of the pattern of the obtained replica mold. As a result, an aspect ratio of 5 was achieved in the 250 nm L&S pattern. Unlike usual glass, because the replica mold material of the present invention is very soft before the ultraviolet irradiation, it was confirmed that a pattern having a still higher aspect ratio can be formed.

### Example 2

The procedure was carried out in the similar manner as in Example 1 except that replica mold material No. 2 was used to form a replica mold. The obtained replica mold was evaluated in the same manner as in Example 1. As a result, as in Example 1, it was confirmed that the pattern of the master mold was amazingly favorably transferred onto the replica mold, and the replica mold obtained in this example had not only excellent hardness and transparency but also outstanding heat resistance, chemical resistance, and aspect ratio.

### Example 3

The procedure was carried out in the similar manner as in Example 1 except that replica mold material No. 3 was used to form a replica mold. The obtained replica mold was evaluated in the same manner as in Example 1. As a result, as in Example 1, it was confirmed that the pattern of the master mold was amazingly favorably transferred onto the replica mold, and the replica mold obtained in this example had not only excellent hardness and transparency but also outstanding heat resistance, chemical resistance, and aspect ratio.

### Example 4

The procedure was carried out in the similar manner as in Example 1 except that replica mold material No. 4 was used to form a replica mold. The obtained replica mold was evaluated in the same manner as in Example 1. As a result, as in Example 1, it was confirmed that the pattern of the master mold was amazingly favorably transferred onto the replica mold, and the replica mold obtained in this example had not only excellent hardness and transparency but also outstanding heat resistance, chemical resistance, and aspect ratio.

### Example 5

The procedure was carried out in the similar manner as in Example 1 except that replica mold material No. 5 was used to form a replica mold. The obtained replica mold was evaluated in the same manner as in Example 1. As a result, as in Example 1, it was confirmed that the pattern of the master mold was amazingly favorably transferred onto the replica mold, and the replica mold obtained in this example had not only excellent hardness and transparency but also outstanding heat resistance, chemical resistance, and aspect ratio.

### Example 6

The procedure was carried out in the similar manner as in Example 1 except that replica mold material No. 6 was used to form a replica mold. The obtained replica mold was evaluated in the same manner as in Example 1. As a result, as in Example 1, it was confirmed that the pattern of the master mold was amazingly favorably transferred onto the replica mold, and the replica mold obtained in this example had not only excellent hardness and transparency but also outstanding heat resistance, chemical resistance, and aspect ratio. Further, the surface contact angle was measured. As a result, the contact angle was 110° C. relative to water. Thus, it was confirmed that the surface energy was lowered, and application of a fluorine-containing silane coupling agent (trichloro(1H,1H, 2H, 2H-perfluorooctyl)silane) (mold release agent) was unnecessary.

### Example 7

The procedure was carried out in the similar manner as in Example 1 except that replica mold material No. 7 was used to form a replica mold. The obtained replica mold was evaluated in the same manner as in Example 1. As a result, as in Example 1, it was confirmed that the pattern of the master mold was amazingly favorably transferred onto the replica mold, and the replica mold obtained in this example had not only excellent hardness and transparency but also outstanding heat resistance, chemical resistance, and aspect ratio. Especially, the hardness was improved to 500 HV.

### Comparative Example 1

In the same manner as in Example 1, a master mold made of quartz through which ultraviolet rays pass was pressed against a replica mold material which was applied to a substrate for imprinting. Subsequently, ultraviolet rays were irradiated in the same manner as in Example 1 except that ultraviolet rays were irradiated from the master mold side. Subsequently, when the master mold was pulled up, the master mold and the replica mold material were adhered to each other in almost all portions, and thus a pattern was not formed substantially.

### Comparative Example 2

A replica mold was produced in the same manner as in Example 1 except that neither oxygen plasma treatment nor ultraviolet irradiation was performed after a master mold was released. The obtained replica mold was evaluated in the same manner as in Example 1. As a result, collapse of a pattern was observed.

### Comparative Example 3

According to the procedure described in Jpn. J. Appl. Phys., 41, 4198 (2002), producing of a replica mold was attempted using hydrogen silsequioxane (HSQ: manufactured by Toray Dow Corning Corporation). The imprinting was performed at 4 MPa and 50° C. An attempt was made to form a similar L&S pattern as that of Example 1 under such conditions. However, a material merely dented slightly and no pattern was formed. Moreover, formation of a pillar-like pattern with a uniform size was attempted, which also ended in failure.

### Comparative Example 4

Production of a replica mold was attempted using PMMA. The imprinting was performed at 150° C., at 4 MPa, and for 10 seconds. Under the conditions, a similar L&S pattern as that of Example 1 was formed. However, when the pattern was baked at 150° C., the pattern disappeared. Moreover, when the obtained replica mold was immersed in acetone, the replica mold immediately dissolved. Further, the Vickers hardness of the obtained replica mold was 100 HV, which was smaller than ⅓ of the Vickers hardness of the replica mold of Example 1.

As is apparent from the results of Examples and Comparative Examples, it was confirmed that when a replica mold is manufactured using a specific replica mold material by the manufacturing method of the present invention, it is possible to obtain a replica mold excellent in all properties of pattern transferring property, hardness, transparency, heat resistance, chemical resistance, and aspect ratio.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A method of manufacturing a replica mold, comprising the steps of:
applying, to a substrate, a replica mold material containing a polysilane and a silicone compound;
pressing a master mold on which a predetermined minute pattern has been formed to the replica mold material which has been applied to the substrate;
irradiating energy rays from a side of the substrate while the master mold is contacted by press with the replica mold material;
releasing the master mold; and
irradiating the replica mold material with energy rays from a side to which the master mold has been pressed.

2. A method of manufacturing a replica mold according to claim 1, further comprising the step of irradiating oxygen plasma after the master mold has been released.

3. A method of manufacturing a replica mold according to claim 1, wherein the step of pressing is performed at about room temperature.

4. A method of manufacturing a replica mold according to claim 3, wherein the step of pressing is performed with a pressure of 1 to 3 MPa.

5. A method of manufacturing a replica mold according to claim 1, further comprising the step of heating the replica mold material after irradiating the energy rays from the side to which the master mold has been pressed.

6. A method of manufacturing a replica mold according to claim 5, wherein the step of heating is performed at 150 to 450° C.

7. A method of manufacturing a replica mold according to claim 1, wherein the replica mold material has an application thickness larger than a height of the minute pattern formed on the master mold.

8. A method of manufacturing a replica mold according to claim 1, further comprising the step of heating the replica mold material before the step of pressing.

9. A method of manufacturing a replica mold according to claim 1, wherein the energy rays comprise ultraviolet rays.

10. A method of manufacturing a replica mold according to claim 1, wherein the step of irradiating energy rays from the side to which the master mold has been pressed is performed in the presence of ozone.

11. A method of manufacturing a replica mold according to claim 1, wherein the replica mold material contains the polysilane and the silicone compound at a weight ratio of 80:20 to 5:95.

12. A method of manufacturing a replica mold according to claim 1, wherein the polysilane comprises a branched polysilane.

13. A method of manufacturing a replica mold according to claim 12, wherein the branched polysilane has a degree of branch of 2% or higher.

14. A method of manufacturing a replica mold according to claim 1, wherein the replica mold material further contains a sensitizer.

15. A method of manufacturing a replica mold according to claim 1, wherein the replica mold material further contains a metal oxide particle.

16. A method of manufacturing a replica mold according to claim 14, wherein the replica mold material further contains a metal oxide particle.

17. A replica mold, which is obtained by the method according to claim 1.

18. A replica mold according to claim 17, which has a plurality of minute patterns with different sizes ranging from 10 nm scale to 10 μm scale formed thereon.

19. A replica mold according to claim 17, which has hardness of 300 HV or higher, light transmittance in a visible region of 90% or higher, and a light transmittance in an ultraviolet region with a wavelength of 300 nm of 70% or higher.

20. A replica mold, having a silicon dioxide structure derived from a polysilane and a silicone compound, wherein the replica mold has:
hardness of 300 HV or higher;
a light transmittance in a visible region of 90% or higher;
a light transmittance in an ultraviolet region with a wavelength of 300 nm of 70% or higher; and
a plurality of minute patterns with different sizes ranging from 10 nm scale to 10 μm scale formed thereon.
